(19) United States
(12) Patent Application Publication
(10) Pub. No.: US 2025/0319641 A1
(43) Pub. Date: Oct. 16, 2025

(54) CO-EXTRUDED HDPE AND TPU FILMS

(71) Applicant: BASF SE, Ludwigshafen am Rhein (DE)

(72) Inventors: Md Arifur RAHMAN, Wayne, MI (US); Jacob Forrest STONEBURNER, Wyandotte, MI (US); Thomas William MCKAY, Greenville, SC (US); Christina Medagelia TAROLA, Clover, SC (US)

(73) Assignee: BASF SE, Ludwigshafen am Rhein (DE)

(21) Appl. No.: 18/866,782

(22) PCT Filed: May 12, 2023
(86) PCT No.: PCT/US2023/021972

§ 371 Date: Nov. 18, 2024

Related U.S. Application Data
(60) Provisional application No. 63/348,760, filed on Jun. 3, 2022.

(51) Int. Cl. B29C 48/21; B29C 48/00; B29C 48/07; B29C 48/92; B29C 51/00; B29C 51/14; B29K 23/00; B29K 75/00; B29K 96/02; B29L 9/00; B29L 31/00

(52) U.S. Cl. CPC B29C 48/21; B29C 48/0017; B29C 48/022; B29C 48/07; B29C 48/92; B29C 51/002; B29C 51/14; B29K 2023/065; B29K 2075/00; B29K 2096/02; B29K 2995/0012; B29K 2995/0089; B29K 2995/0097; B29K 2995/0098; B29L 2009/00; B29L 2031/7138

(57) ABSTRACT

The present invention provides high-density polyethylene (HDPE)/thermoplastic polyurethane (TPU) multilayered sheet, dunnage tray including HDPE/TPU multilayered sheet, methods of producing the same, and methods of recycling the same. The HDPE/TPU multilayered sheets described herein include functionalized HDPE. The methods described herein includes including co-extruding HDPE, functionalized HDPE and TPU, and optionally thermoforming the HDPE/TPU multilayered sheet. The HDPE/TPU multilayered sheets described herein have enhanced adhesion and peeling properties, as well as cold and impact resistance.

### BACKGROUND OF THE INVENTION

### Field of the Invention

The present invention relates generally to formulations of HDPE and TPU, and more specifically to co-extrusion of HDPE and TPU multilayered sheets.

### Background Information

Dunnage trays are designed to carry heavy weight machine tools. Dunnage is the name for the durable padding materials used in holds and containers to protect packaged goods from moisture, contamination, and mechanical damage during shipping (e.g., loose material laid beneath or wedged among objects carried by ship or rail to prevent injury from chafing or moisture, or to provide ventilation). Trays are thermoformed into shapes of different machine parts. Thus, such trays need to withstand heavy loads at certain environmental condition and require abrasion resistance at the surface. Conventionally, such trays are made via extrusion of acrylonitrile butadiene styrene (ABS) and thermoplastic polyurethane (TPU) films following an overmolding process where TPU film is overmolded on top of ABS film surface and then thermoformed to shapes that are specific to objects to be carried (e.g., tools).

The use of TPU in automotive dunnage applications is well-established. Co-extruded sheets of TPU-ABS provide excellent abrasion resistance, durability, oil-resistance, and can protect components with sharp edges. Despite these properties, TPU-ABS co-extruded thermoforms have some disadvantages. In addition to higher costs for ABS resins, the poor performance of ABS in cold weather and brittle tendences during impacts can limit the lifecycle of dunnage trays.

Therefore, there is an unmet need for alternative to co-extruded sheets of TPU-ABS for the production of dunnage trays. Provided herein are formulations of HDPE and TPU developed to produce co-extruded, multilayered sheets with good adhesion between HDPE and TPU.

### SUMMARY OF THE INVENTION

The present invention is based on the seminal discovery that functionalized HDPE can be used to improve its adhesion to TPU to produce co-extruded, multilayered sheets that can be used for the production of highly resistant and recyclable dunnage trays.

In one embodiment, the present invention provides a method of producing a high-density polyethylene (HDPE)/thermoplastic polyurethane (TPU) multilayered sheet including co-extruding HDPE and TPU, wherein the HDPE includes unfunctionalized and functionalized HDPE, thereby producing a HDPE/TPU multilayered sheet.

In one aspect, the HDPE/TPU multilayered sheet includes one or more layers of TPU and one or more layers of HDPE. In some aspects, the HDPE/TPU multilayered sheet includes one layer of HDPE and one layer of TPU or one layer of HDPE and two layers of TPU. In some aspects, the functionalized HDPE includes grafted maleic anhydride HDPE (HDPE-g-MA). In one aspect, the modified HDPE includes from about 0.1 to 1.5% g-MA. In some aspects, the modified HDPE includes about less than 0.2% g-MA, about 1% g-MA or about 1.3% g-MA. In another aspect, the HDPE layer includes from about 0.1 to 40 wt % of HDPE-g-MA. In some aspects, the HDPE layer includes about 5, about 10, about 15, or about 30 wt % of HDPE-g-MA. In one aspect, the HDPE is selected from the group consisting of HDPE, HDPE/NL, HDPE/04, and HDPE/05. In another aspect, the TPU is a polyester or a polyether. In various aspects, the TPU is selected from the group consisting of E B 85 A 10, E C 90 A 10, E 688 A 10, E 785 A 10, E 685 A 10, E 1180 A 10, E C 85 A 10 and E 1185 A 10. In various aspects, the HDPE/TPU multilayered sheet comprises a combination of HDPE and TPU selected from the group consisting of HDPE/E B 85 A 10, HDPE/E B 85 A 10, HDPE/E C 90 A 13, HDPE/E 688 A 10, HDPE/E 785 A 10, HDPE/E 1185 A 10, HDPE-NL/E B 85 A 10, HDPE-04/E B 85 A 10, and HDPE-05/E B 85 A 10. In one aspect, co-extruding HDPE and TPU incudes heating HDPE and TPU at a temperature that ranges from about 150° C. to 250° C. In some aspects, the heating temperature is about 180, about 200, about 220 or about 240° C.

In another embodiment, the invention provides a HDPE/TPU multilayered sheet obtained by any one of the methods describes herein.

In one aspect, the HDPE/TPU multilayered sheet has an increased adhesion strength as compared to a HDPE/TPU multilayered sheet that does not include functionalized HDPE. In some aspects, the adhesion strength increases with increasing g-MA content. In another aspect, the HDPE/TPU multilayered sheet has an increased t-peel strength as compared to a HDPE/TPU multilayered sheet that does not include functionalized HDPE. In some aspects, the HDPE/TPU multilayered sheet is non-peelable. In one aspect, the sheet has a thickness that ranges from about 1 to 5 mm. In another aspect, the sheet is cold resistant and/or impact resistant.

In an additional embodiment, the invention provides a method of producing a dunnage tray including: producing a HDPE/TPU multilayered sheet, and thermoforming the HDPE/TPU multilayered sheet, thereby producing a dunnage tray.

In one aspect, producing the HDPE/TPU multilayered sheet includes co-extruding HDPE and TPU.

In a further embodiment, the invention provides a dunnage tray obtained by any one of the methods described herein.

In one aspect, the tray is cold resistant and/or impact resistant.

In one embodiment, the invention provides a method of recycling a HDPE/TPU dunnage tray including: (i) grinding a HDPE/TPU multilayered sheet dunnage tray; and (ii) co-extruding the grinded HDPE/TPU multilayered sheet and TPU to generate a recycled HDPE-TPU/TPU multilayered sheet, thereby recycling the HDPE/TPU dunnage tray.

In one aspect, the recycled HDPE-TPU/TPU multilayered sheet has adhesion strength and t-peel strength that are equivalent to a non-recycled HDPE-TPU/TPU multilayered sheet.

### BRIEF DESCRIPTION OF THE DRAWINGS

FIG. 1 is a graph illustrating the viscosity match temperature for different TPU and HDPE.

FIG. 2 is a schematic representation of the co-extrusion process

FIG. 3 is a schematic representation of the process of recycling HDPE/TPU co-extruded sheet or thermoformed products.

FIG. 4 is a graph illustrating the adhesion of functional HDPE to different TPU grades.

FIG. 5 is a graph illustrating the adhesion strength of different B 85 grades and C 90 A 13 with functional HDPE (30% HDPE-g-MA/70% HDPE).

FIG. 6 is a graph illustrating the adhesion of different TPU chemistries against functional HDPE (i.e., 30% HDPE-g-MA/70% HDPE).

FIGS. 7A-7D are photographs illustrating AFM images showing the interface and interphases of HDPE/TPU co-extruded systems.

FIGS. 8A-8D are photographs illustrating AFM images of co-extruded systems containing recycled HDPE-05/B 85 A10 and B 85 A 10.

FIGS. 9A-9B are graphs illustrating the effect of aging on the adhesion between functional HDPE and TPU (B 85 A 10).

FIG. 10 is a graph illustrating T-peel strength of thermoformed TPU (B85A10 and E785A10)/HDPE-04 Coextruded sheets.

### DETAILED DESCRIPTION OF THE INVENTION

The present invention is based on the seminal discovery that functionalized HDPE can be used to improve its adhesion to TPU to produce co-extruded, multilayered sheets that can be used for the production or highly resistant and recyclable dunnage trays.

Before the present compositions and methods are described, it is to be understood that this invention is not limited to particular compositions, methods, and experimental conditions described, as such compositions, methods, and conditions may vary. It is also to be understood that the terminology used herein is for purposes of describing particular embodiments only, and is not intended to be limiting, since the scope of the present invention will be limited only in the appended claims.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

All publications, patents, and patent applications mentioned in this specification are herein incorporated by reference to the same extent as if each individual publication, patent, or patent application was specifically and individually indicated to be incorporated by reference.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, it will be understood that modifications and variations are encompassed within the spirit and scope of the instant disclosure. The preferred methods and materials are now described.

In one embodiment, the present invention provides a method of producing a high-density polyethylene (HDPE)/thermoplastic polyurethane (TPU) multilayered sheet including co-extruding HDPE and TPU, wherein the HDPE includes unfunctionalized and functionalized HDPE, thereby producing a HDPE/TPU multilayered sheet.

“High-density polyethylene”, “HDPE”, “polyethylene high-density” or “PEHD” as used herein refers to a thermoplastic polymer produced from the monomer ethylene. It is sometimes called “alkathene” or “polythene” when used for HDPE pipes. With a high strength-to-density ratio, HDPE is used in the production of plastic bottles, corrosion-resistant piping, geomembranes and plastic lumber. HDPE is commonly recycled and has the number “2” as its resin identification code. HDPE is known for its high strength-to-density ratio. The density of HDPE ranges from 930 to 970 kg/m³. HDPE has little branching, giving it stronger intermolecular forces and tensile strength (38 MPa versus 21 MPa) than low-density polyethylene (LDPE). The difference in strength exceeds the difference in density, giving HDPE a higher specific strength. It is also harder and opaquer and can withstand somewhat higher temperatures (120° C./248° F. for short periods). High-density polyethylene, unlike polypropylene, cannot withstand normally required autoclaving conditions. The lack of branching is ensured by an appropriate choice of catalyst (e.g., Ziegler-Natta catalysts) and reaction conditions.

HDPE is resistant to many different solvents, so it cannot be glued. The physical properties of HDPE can vary depending on the molding process that is used to manufacture a specific sample; to some degree, a determining factor is the international standardized testing methods employed to identify these properties for a specific process. For example, in rotational molding, to identify the environmental stress crack resistance of a sample, the notched constant tensile load test (NCTL) is put to use. Owing to these desirable properties, pipes constructed out of HDPE are ideally applicable for drinking water and wastewater (storm and sewage).

HDPE applications are varied, and include—without being limited to—rope, disposable suits; nonwoven HDPE fabric, plastic mailing envelopes, flexible HDPE pipes, corrugated HDPE pipe installation in storm drain, outdoor furniture, bottle crates, toys and playground equipment, clear plastic bags; blown-film shopping bags with handles, sturdy bottles that resist oils, jerrycans, 3D printer filament, arena board (puck board), backpacking frames, ballistic plates, banners, bottle caps, boats, chemical containers, chemical-resistant piping, coax cable inner insulator, conduit protector for electrical or communications cables, corrosion protection for steel pipelines, electrical and plumbing boxes, far-IR lenses, fireworks, folding chairs and tables, food storage containers, fuel tanks for vehicles, geomembrane for hydraulic applications (such as canals and bank reinforcements), geothermal heat transfer piping systems, heat-resistant firework mortars, in
housewrap (tyvek), hovercraft: the material is too heavy and dense for such craft but is still used occasionally, ionizing radiation shield, laundry detergent jugs, lasts for shoes, microwave telescope windows, milk jugs, natural gas distribution pipe systems, piping for fluid, slurry and gas purposes, plastic bags, plastic bottles suitable both for recycling or re-use, plastic surgery (skeletal and facial reconstruction), potable water mains, root barrier, shampoo bottles, sewage mains, snowboard rails and boxes, stone paper, storage sheds, swimming pool installation, trackout control mats, telecom ducts, water pipes for domestic water supply and agricultural processes, Wood plastic composites (utilizing recycled polymers). HDPE has a wide variety of applications; for applications that fall within the properties of other polymers, the choice to use HDPE is usually economic.

In one aspect, the HDPE is selected from the group consisting of HDPE, HDPE/NL, HDPE/04, and HDPE/05.

As used herein, the terms “HDPE”, “HDPE/NL”, “HDPE/04”, and “HDPE/05” refer to various types of HDPE having different functionality and/or properties such as density, melt flow index (MFI), and melt temperature. The different characteristics of the HDPEs described herein are summarized in Table 1.

TABLE 1
HDPEs characteristics

| | | | | MFI | |
|---|---|---|---|---|---|
| | | | | (190° C./ | Melt |
| Different | | | Density | 2.16 kg) | Temperature |
| HDPEs | Functionality | MA % | (g/cm³) | (g/10 min) | (° C.) |
| HDPE | none | 0 | 0.965 | 8.3 | 133 |
| homopolymer | | | | | |
| HDPE/NL | Grafted maleic | <0.2 | 0.940 | 3.5 | 135 |
| HDPE/04 | anhydride (MA) | 1.0 | 0.954 | 12.0 | 127 |
| HDPE/05 | | 1.3 | 0.960 | 2.0 | 130 |

“Thermoplastic polyurethane” or “TPU” is any of a class of polyurethane plastics with many properties, including elasticity, transparency, and resistance to oil, grease, and abrasion. Technically, they are thermoplastic elastomers consisting of linear segmented block copolymers composed of hard and soft segments. TPU is a block copolymer consisting of alternating sequences of hard and soft segments or domains formed by the reaction of (1) diisocyanates with short-chain diols (so-called chain extenders) and (2) diisocyanates with long-chain diols. By varying the ratio, structure and/or molecular weight of the reaction compounds, an enormous variety of different TPU can be produced. This allows urethane chemists to fine-tune the polymer's structure to the desired final properties of the material.

A TPU resin consists of linear polymeric chains in block-structures. Such chains contain low polarity segments which are rather long (called soft segments), alternating with shorter, high polarity segments (called hard segments). Both types of segments are linked together by covalent links so that they actually form block-copolymers. The miscibility of the hard and soft segments in TPU depends on the differences in their glass transition temperature (Tg) which occurs at the onset of micro-Brownian segmental motion, identifiable by dynamic mechanical spectra. For an immiscible TPU, the loss modulus spectrum typically shows double peaks, each of which is assigned to the Tg of one component. If the two components are miscible, the TPU will be characterized by a single broad peak whose position lie between that of the two original Tg peaks of the pure components.

The polarity of the hard pieces creates a strong attraction between them, which causes a high degree of aggregation and order in this phase, forming crystalline or pseudo crystalline areas located in a soft and flexible matrix. This so-called phase separation between both blocks can be more or less important, depending on the polarity and the molecular weight of the flexible chain, the production conditions, etc. The crystalline or pseudo crystalline areas act as physical cross-links, which account for the high elasticity level of TPU, whereas the flexible chains will impart the elongation characteristics to the polymer. These “pseudo crosslinks”, however, disappear under the effect of heat, and thus the classical extrusion, injection molding, and calendaring processing methods are applicable to these materials. Consequently, TPU scrap can be reprocessed.

TPU has many applications, including automotive instrument panels, caster wheels, power tools, sporting goods, medical devices, drive belts, footwear, inflatable rafts, and a variety of extruded film, sheet and profile uses. TPU is also a popular material found in flexible outer cases of devices like mobile phones and keyboard protectors. TPU is well known for its applications in wire and cable jacketing, hose and tube, in adhesive and textile coating applications, and as an impact modifier of other polymers. It is also used in high-performance films, such as high impact resistant glass structures.

TPU is the thermoplastic elastomer used in fused filament deposition (FFD) 3D printing. The absence of warping and lack of need for primer makes it an ideal filament for 3D printers when objects need to be flexible and elastic. Since TPU is a thermoplastic, it can be melted by the 3D printer's extruder, printed, then cooled back into an elastic solid. TPU powders are also used for other 3D printing processes, like selective laser sintering (SLS) and 3D inkjet printing. It's also used in large vertical injection or extrusion molding machines to print directly without the intermediate step of filament extrusion or powder preparation. Commercially available TPU has high abrasion resistance, low-temperature performance, high shear strength, high elasticity, transparency, and oil and grease resistance

The currently available TPUs can be divided mainly in two groups, based on soft segment chemistry: polyester-based TPUs (mainly derived from adipic acid esters) and polyether-based TPUs (mainly based on tetrahydrofuran (THF) ethers).

In one aspect, the TPU is a polyester or a polyether. In various aspects, the TPU is selected from the group consisting of E B 85 A 10, E C 90 A 10, E 688 A 10, E 785 A 10, E 685 A 10, E 1180 A 10, E C 85 A 10 and E 1185 A 10.

As used herein, the terms “E B 85 A 10”, “E C 90 A 10”, “E 688 A 10”, “E 785 A 10”, “E 685 A10”, “E1180 A 10”, “E C 85 A 10” and “E 1185 A 10.” refer to various types of TPU having different formulations. The different formulations of the TPUs described herein are summarized in Tables 2-6.

TABLE 2
E 1180 A 10formulation

| | PTHF 1010 | Lupranat MES | 1,4-Butandiol | Irganox B1125 |
|---|---|---|---|---|
| | weight (%) | weight (%) | weight (%) | weight (%) |
| E 1180 A10 | 1000 (61.40) | 520 (31.93) | 97.14 (5.96) | 11.40 (0.70) |

TABLE 3
E 785 A10 formulation

| | | Lupranat | | Elastostab | Crodamine EBS |
|---|---|---|---|---|---|
| | Capa 2201 | MET | 1,4-Butandiol | H01 | Microbead |
| | weight (%) | weight (%) | weight (%) | weight (%) | weight (%) |
| E 685 A10 | 59.67 (59.676) | 31.19 (31.193) | 8.61 (8.611) | 0.47 (0.47) | 0.05 (0.050) |

TABLE 4
E B 85 A 10 formulation

| | Lupraphen 6605/1 | Lupranat MET | 1,4-Butandiol | Elastostab H01 |
|---|---|---|---|---|
| | weight (%) | weight (%) | weight (%) | weight (%) |
| E B 85 A 10 | 1000 (66.664) | 390 (25.999) | 102.06 (6.804) | 8 (0.533) |

TABLE 5
E C 85 A 10 formulation

| | Lupraphen | Lupranat | 1,4- | Elastostab | |
|---|---|---|---|---|---|
| | VP9066 | MES | Butandiol | H01 | Loxiol EBS V |
| | weight (%) | weight (%) | weight (%) | weight (%) | weight (%) |
| E C 85 A 10 | 1000 (64.004) | 440 (28.162) | 111.62 (7.144) | 10 (0.640) | 0.78 (0.050) |

TABLE 6
E 685 A10 formulation

| | Lupraphen 1010 | Lupranat MES | 1,4-Butandiol | Elastostab H01 |
|---|---|---|---|---|
| | weight (%) | weight (%) | weight (%) | weight (%) |
| E 685 A10 | 1000 (60.823) | 535 (32.540) | 101.12 (6.150) | 8 (0.487) |

In various aspects, the HDPE/TPU multilayered sheet comprises a combination of HDPE and TPU selected from the group consisting of HDPE/E B 85 A 10, HDPE/E B 85 A 10, HDPE/E C 90 A 13, HDPE/E 688 A 10, HDPE/E 785 A 10, HDPE/E 1185 A 10, HDPE-NL/E B 85 A 10, HDPE-04/E B 85 A 10, and HDPE-05/E B 85 A 10.

The present invention provides for methods of producing HDPE/TPU multilayer sheet. By “HDPE/TPU multilayer sheet” or “HDPE/TPU multilayer film”, it is meant a composite plastic material that comprises one or more layers of HDPE and/TPU, stacked one on top of the other. For example, the composite plastic material can comprise one or more (e.g., 1, 2, 3, 4 or more) layers of HDPE, and/or one or more (e.g., 1, 2, 3, 4 or more) layers of TPU. The layers can be alternated between HDPE and TPU in any order.

Traditionally TPU and HDPE do not adhere to one another, but the addition of functionalized HDPE improves interfacial adhesion between the two. There has been numerous works on improving the adhesion between HDPE with polar polymers. In most cases, improvement of HDPE adhesion focuses on functionalizing the HDPE to reduce the polarity difference at the interface. Functional groups such as maleic anhydride, alkylated maleic anhydride and/or amine grafted HDPE adheres better with TPU than neat HDPE. In addition, co-extrusion process also improves the interfacial adhesion due to the extensional and compressive flow, which helps the reactive species to penetrate the interface.

As used herein the term “functionalized HDPE” refers to a HDPE polymer that is modified with a functional group to alter its properties, for examples to improve its adhesion to TPU. In some aspects, the functionalized HDPE includes grafted maleic anhydride HDPE (HDPE-g-MA).

The methods described herein includes co-extruding HDPE and TPU. By “co-extruding”, it is meant that HDPE and TPU are extruded together to form an extrudate composed of different layers of each of HDPE and TPU by a way of combining layers of melted HDPE and TPU.

In one aspect, the HDPE/TPU multilayered sheet includes one or more layers of TPU and one or more layers of HDPE.

In some aspect, the HDPE/TPU multilayered sheet includes 1, 2, 3, 4 or more layers of HDPE, and 1, 2, 3, 4 or more layers of TPU. In one aspect, the HDPE/TPU multilayered sheet includes one layer of HDPE and one layer of TPU

In another aspect, the HDPE/TPU multilayered sheet includes one layer of HDPE and two layers of TPU. In various aspects, the HDPE layer is surrounded by the two layers of TPU (e.g., there is one layer of TPU on top of the HDPE layer, and one TPU layer below the HDPE layer).

In another aspect, the HDPE layer includes a blend of unfunctionalized HDPE and functionalized HDPE.

The incorporation of functionalized HDPE in the HDPE/TPU multilayered sheet is partial, that is not all the HDPE is modified to be functionalized HDPE, but rather a portion of the total HDPE amount is functionalized. Therefore, the HDPE content in the HDPT/TPU multilayered sheet is a blend that include unmodified (or unfunctionalized) HDPE and functionalized HDPE. The content of functionalized HDPE in the HDPT/TPU multilayered sheet can be measured as a ratio of functionalized HDPE:unfunctionalized HDPE, or as a total content of functionalized in the HDPT/TPU multilayered sheet. For example, the ratio of functionalized HDPE:unfunctionalized HDPE can range from about 1:1000 to 1:20. Alternatively, the amount of functionalized HDPE can be measured as a percent of modified HDPE as compared to the total content of HDPE.

In one aspect, the modified HDPE includes from about 0.1 to 1.5% g-MA. In some aspects, the modified HDPE includes about less than 0.2% g-MA, about 1% g-MA or about 1.3% g-MA.

In another aspect, the HDPE layer includes from about 0.1 to 40 wt % of HDPE-g-MA.

In some aspects, the HDPE layer includes about 5, about 10, about 15, or about 30 wt % of HDPE-g-MA.

When co-extruding HDPE and TPU, both polymers are feed into an extruder, and are heated at a temperature that is at least as high as the melting point of the polymer, such that the polymers are melted. Therefore, the co-extruding step of the method described herein includes a heating step. To ensure melting of the polymers, the heating temperature is at least about 100° C. and up to about 400° C. For example, the heating temperature ranges from about 100-200° C., from about 200-300° C., from about 300-400° C., from about 100-300° C., from about 200-400° C., from about 150-250° C., from about 250-350° C., or from about 150-300° C.

In one aspect, co-extruding HDPE and TPU includes heating HDPE and TPU at a temperature that ranges from about 150° C. to 250° C. In some aspects, the heating temperature is about 180, about 200, about 220 or about 240° C.

In another embodiment, the invention provides a HDPE/TPU multilayered sheet obtained by any one of the methods describes herein.

In one aspect, the HDPE/TPU multilayered sheet has an increased adhesion strength as compared to a HDPE/TPU multilayered sheet that does not include functionalized HDPE.

As used herein, the term “adhesion strength” refers to a measure of how strong the bond between two materials is. This can be done in terms of load, stress, energy or work required to break the interphase. An adhesion strength can be measured by: a tensile test, a conventional mechanical test which measures the resistance of a material to the gradual application of uniaxial strain; a peeling test, a technique frequently used to measure the adhesion strength between two materials (different configurations of peeling test may be used by changing the crack opening angle); and/or an Essential Work of Interfacial Fracture (EWIF), a method that derived from the Essential Work of Fracture (EWF) methodology which has been used satisfactorily to determine the fracture behavior of many ductile polymeric systems. As used herein, the interfacial adhesion strength was characterized as the function of TPU chemistry and concentration of functionalized HDPE in the layered system. In some aspects, the adhesion strength increases with increasing g-MA content.

In one aspect, the HDPE/TPU multilayered sheet has an increased adhesion strength as compared to a HDPE/TPU multilayered sheet that does not comprise functionalized HDPE. In another aspect, the HDPE/TPU multilayered sheet has an increased t-peel strength as compared to a HDPE/TPU multilayered sheet that does not include functionalized HDPE.

For example, an HDPE/TPU multilayered sheet having an HDPE layer including about 30 wt % of HDPE-g-MA, has an increased adhesion strength as compared to a HDPE/TPU multilayered sheet that includes 0%, about 5%, about 10%, or about 15 wt % of HDPE-g-MA.

For example, an HDPE/TPU multilayered sheet having an HDPE layer including about 30 wt % of HDPE-g-MA, has an increased t-peel strength as compared to a HDPE/TPU multilayered sheet that includes 0%, about 5%, about 10%, or about 15 wt % of HDPE-g-MA.

In some aspects, the t-peel strength of the HDPE/TPU multilayered sheet is so strong that it is virtually not possible to peel HDPE layer from the TPU layer regardless of the strength applied. In such cases, the no t-peel strength can be measured. In some aspects, the HDPE/TPU multilayered sheet is non-peelable.

The thickness of the sheet may vary depending on the thickness of each layer (of HDPE and TPU, individually), and depending on the number of layers (e.g., for a given thickness of on layer, a multilayer sheet that includes three layers may be thicker than a multilayer sheet that includes two layers). On layer of polymer (e.g., a HDPE layer or a TPU layer) can have a thickness that ranges from about 100 μm to 2 mm. for example, a polymer layer can have a thickness of about 100 μm, 200 μm, 300 μm, 400 μm, 500 μm, 600 μm, 700 μm, 800 μm, 900 μm, 1,000 μm, 1,250 μm, 1,500 μm, 1,750 μm, or 2,000 μm. A HDPE/TPU multilayered sheet can comprise 2 or more layers and have a thickness of about 200 μm to 5 mm. For example, a HDPE/TPU multilayered sheet can have a thickness of about 200 μm, 400μ, 500 μm, 600 μm, 750μ, 800 μm, 1,000 μm, 1,250 μm, 1,500μ, 1,750 μm, 2,000 μm, 2,500 μm, 3,000 μm, 3,500 μm, 4,000 μm, 4,500 μm or 5,000 μm. In some aspects, the sheet has a thickness that ranges from about 1 to 5 mm. In one aspect, the sheet has a thickness of about 2 mm.

In an additional embodiment, the invention provides a method of producing a dunnage tray including producing a HDPE/TPU multilayered sheet, and thermoforming the HDPE/TPU multilayered sheet, thereby producing a dunnage tray.

As used herein, the term “dunnage tray” refers to a tray that is design for the shipping, handling, and/or processing of parts or products for a variety of applications. These trays are specially engineered to protect the parts during shipment handling, and/or processing.

In one aspect, producing the HDPE/TPU multilayered sheet includes co-extruding HDPE and TPU. In another aspect, producing the dunnage tray does not include overmolding. The methods described herein, using HDPE/TPU multilayered sheet does not require an injection molding step to generate a dunnage tray. Instead, the multilayered sheet is thermoformed, which allows the generation of the dunnage tray. During the thermoforming step, the HDPE/TPU multilayered sheet is heated to its softening point, the sheet is then stretched across a single-sided mold and manipulated. Then, it cools into the desired shape (e.g., the shape of the part of product to be hold in the dunnage tray).

In a further embodiment, the invention provides a dunnage tray obtained by any one of the methods described herein.

In one aspect, the tray is cold resistant and/or impact resistant.

By “cold resistant”, it is meant that the properties of the dunnage tray (e.g., which reflects the properties of the HDPE/TPU multilayered sheet) are not altered by changes in the temperature, especially by exposure of the tray to cold temperatures. For example, the adhesion strength and the t-peel strength of the tray are not altered if the tray is exposed to cold temperature. By “altered”, it is meant that the tray's properties are either unchanged and changed to an extend that is not sufficient to render the tray unusable or having properties that render it ineffective. By “cold temperature” it is meant temperatures that are below room temperature. For example, cold temperatures include temperatures ranging from about −20° C. to 20° C., e.g., −20, −18, −16, −14, −12, −10, −8, −6, −4, −2, 0, 2, 4, 6, 8, 10, 12, 14, 16, 18 and 20° C.

By “impact resistant” is it meant that if subjected to impact of any sort, the HDPE/TPU multilayered sheet does not have a tendency to brittle, which can limit the lifecycle of the sheet (and therefore of the product derived therefrom, such as HDPE/TPU multilayered sheet dunnage tray). Accordingly, the HDPE/TPU multilayered sheet and dunnage tray derived therefrom described herein, which is impact resistant has an extended lifecycle as compared to conventional HDPE/TPU multilayered sheet and dunnage tray (e.g., those that are not formed using HDPE/TPU, where HDPE is a blend of unfunctionalized HDPE and functionalized HDPE.

In one embodiment, the invention provides a method of recycling a HDPE/TPU dunnage tray including: (i) grinding a HDPE/TPU multilayered sheet dunnage tray; and (ii) co-extruding the grinded HDPE/TPU multilayered sheet and TPU to generate a recycled HDPE-TPU/TPU multilayered sheet, thereby recycling the HDPE/TPU dunnage tray.

The term “recycling” as used herein, refers to the transformation of a pre-formed material into base material or element that can in turn be used for the generation of a “recycled” material. In the methods described herein, “recycling” a HDPE/TPU dunnage trays refers in general to the transformation of previously formed (“pre-formed”) a HDPE/TPU dunnage tray or materials (e.g., pre-formed HDPE/TPU multilayered sheet) into HDPE/TPU dunnage tray or multilayered sheet fragments, that can be used for the production of recycled HDPE/TPU dunnage tray or material such as recycled HDPE/TPU multilayered sheet.

Any previously formed HDPE/TPU dunnage tray or multilayered sheet may be used, including those that were used for a prior intended purpose or were otherwise not used for any intended purpose (i.e., virgin material, such as scrap or unused commercial products and the like) as pre-formed material. The HDPE/TPU dunnage tray or multilayered sheet fragments are a base material that can be used in the production of any HDPE/TPU dunnage tray or multilayered sheet, regardless of the type of HDPE/TPU combination that it was derived from.

The term “recycled”, as used hereinafter in the phrase “recycled articles”, refers in general to the use of previously formed (“pre-formed”) objects or materials. In other words, any previously formed object or material may be used, including those that were used for the prior intended purpose or were otherwise not used for any intended purpose. In other words, the only requirement is for the HDPE/TPU article to be considered a “recycled HDPE/TPU article” as used herein is that it was a pre-formed HDPE/TPU object or material and is now available for use. The recycled HDPE/TPU articles may be in the form of multilayered sheet or thermoformed dunnage tray and any combination thereof.

As used herein, the term “grinding” of the HDPE/TPU article is meant to refer to any process that is applied to the article that results in an increase in the HDPE/TPU article density, a decrease in the HDPE/TPU article volume, or a combination thereof. Examples of methods to increase HDPE/TPU article density include but are not limited to grinding, compaction, compression, milling, crushing, squeezing, and the like. In various aspects, processing and/or grinding comprises using a grinder, a processor, a shredder, a granulator, a crusher, a compactor or a miller. In another aspect, the processing of the HDPE/TPU article yield shredded HDPE/TPU article fragments. Increase the HDPE/TPU article density or decreasing the HDPE/TPU article volume (e.g., grinding) includes generating fragments of HDPE/TPU article that are smaller in size than the initial HDPE/TPU piece.

In one aspect, the recycled HDPE-TPU/TPU multilayered sheet has adhesion strength and t-peel strength that are equivalent to a non-recycled HDPE-TPU/TPU multilayered sheet.

Presented below are examples discussing co-extruded HDPE/TPU multilayered sheet contemplated for the discussed applications. The following examples are provided to further illustrate the embodiments of the present invention but are not intended to limit the scope of the invention. While they are typical of those that might be used, other procedures, methodologies, or techniques known to those skilled in the art may alternatively be used.

### EXAMPLES

### Example 1

### Materials and Methods

### Materials

Table 7 presents the list of materials used herein.

TABLE 7

| Different | | | | |
|---|---|---|---|---|
| HDPEs | Functionality | MA % | Different TPU | Polyol |
| HDPE | none | 0 | E B 85 A 10 (Polyester) | Adipate |
| HDPE/NL | Grafted maleic | <0.2 | E C 90 A 10 (Polyester) | Adipate |
| HDPE/04 | anhydride (MA) | 1 | E 688 A 10 (polyester) | Adipate |
| HDPE/05 | | 1.3 | E 785 A 10 (polyester) | Caprolactone |
| | | | E 1185 A 10 | polyTHF |
| | | | (polyether) | |

### Co-Extrusion Process

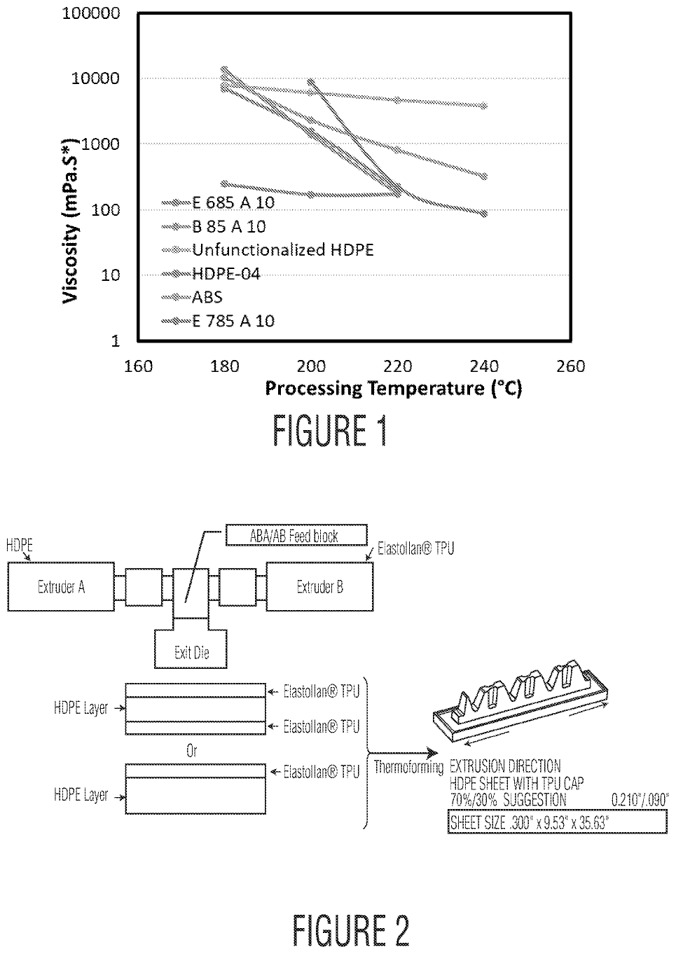

The co-extrusion of HDPE and TPUs was conducted using a Collin extrusion line equipped with an ABA feedblock. The composition of co-extruded layers in the films can be controlled by the volumetric melt flow of polymers. In order to ensure uniform layer integrity, the processing temperature is determined based on the viscosity match of two polymers at melt. A melt flow indexer was used to measure the apparent viscosity of both HDPE and TPU. As illustrated in FIG. 1 the viscosity match temperature for different formulations of HDPE and TPU was evaluated. In addition, as showed in FIG. 2 the co-extrusion process allowed the production of three-layer HDPE and TPU co-extruded sheets. The three-layer systems of TPU/HDPE/TPU with a composition of 15/70/15 (v/v) and thickness of 2 mm were produced via co-extrusion technology. Table 8 presents a list of co-extruded layered systems of HDPE/TPU produced.

TABLE 8
List of co-extruded HDPE/TPU systems.

| Co-extruded systems | HDPE Layer | TPU Layer |
|---|---|---|
| HDPE/E B 85 A 10 | Unfunctionalized HDPE | E B 85 A 10 |
| HDPE/E B 85 A 10 | HDPE/HDPE-g-MA blend | E B 85 A 10 |
| HDPE/E C 90 A 13 | (5, 10, 15, 30 wt % | E C 90 A 13 |
| HDPE/E 688 A 10 | of HDPE-g-MA) | E 688 A 10 |
| HDPE/E 785 A 10 | | E 785 A 10 |
| HDPE/E 1185 A 10 | | E 1185 A 10 |
| HDPE-NL/E B 85 A 10 | HDPE-g-MA (<0.2%) | E B 85 A 10 |
| HDPE-04/E B 85 A 10 | HDPE-g-MA (1%) | E B 85 A 10 |
| HDPE-05/E B 85 A 10 | HDPE-g-MA (1.3%) | E B 85 A 10 |

### Recycling Process

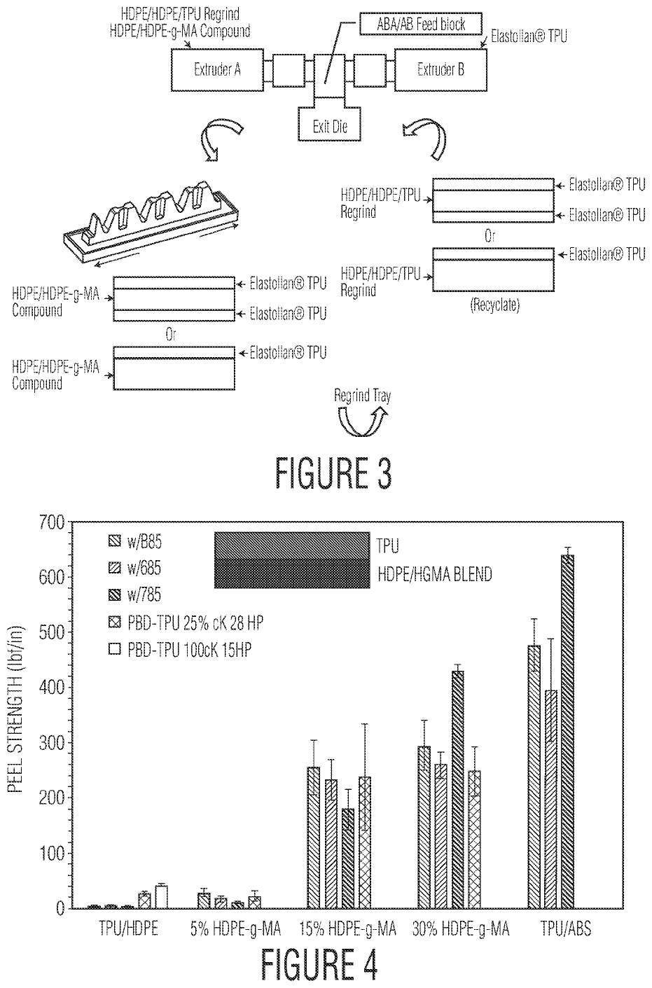

In order to develop recycling process on the extruded HDPE/TPU sheets, regrinds were produced to produce the sheets. This means the HDPE/TPU co-extruded sheets were processed three times to produce three regrinds and each time regrinds replaced the core HDPE layer with regrinds while keeping the same TPU layers as the confining layer for regrinds in place of HDPE. FIG. 3 depicts the recycling process. Table 9 provides a list of regrinds produced for the recycling study.

TABLE 9
List of HDPE/TPU regrinds produced.

| Regrinds | Definitions | TPU Layer | Core Layer |
|---|---|---|---|
| HDPE/TPU Co-ex | As produced | E B 85 A 10 | HDPE-05 |
| sheet - R0 | sheet | | |
| 1^{st} Regrind - R1 | Griding of as | E B 85 A 10 | R1 |
| | produced sheet | | |
| 2^{nd} Regrind - R2 | Grinding of R1 | E B 85 A 10 | R2 |
| 3^{rd} Regrind - R3 | Grinding of R2 | E B 85 A 10 | R3 |

### Adhesion Strength

Compression molding of different HDPE/TPU systems were conducted to determine the pairs of HDPE and TPU for co-extrusion study. Films of HDPE and TPU were compressed at the viscosity match temperature as determined by melt flow indexer to prepare the t-peel samples. ASTM D1876 was followed to prepare specimens and test was conducted in a mechanical testing machine. Similarly, co-extruded samples were also analyzed for interfacial strength.

### AFM (Atomic Forced Microscopy)

Standard AFM analyses were conducted to observe the morphology at the interface of co-extruded sheets.

### DSC (Differential Scanning Calorimetry)

DSC was conducted on each co-extruded sheets to understand the effect of co-extrusion process on their thermal transitions.

### Mechanical Properties

DIN53516 was followed to measure the abrasion loss of coextruded HDPE/TPU sheets.

In addition, ASTM D412 was followed to measure the tensile and ASTM D624 was used to measure the tear strength of co-extrude sheets.

### Thermoforming

Co-Extruded samples were thermoformed on a Formech 508DT vacuum thermoforming machine. This is a small desktop unit that can form samples approximately 300 mm². Temperatures were adjusted to allow the material to be formed around the mold without melting out of the frame or tearing.

### Example 2

### Evaluation of the Interfacial Strength of Compression Molded Sheets

As shown in FIG. 4 the effect of concentration of HDPE-g-MA in blends of HDPE/HDPE-g-MA on the adhesion of different TPU grades was evaluated. It can be observed that the adhesion strength of unfunctionalized HDPE and TPU was very low which was expected due to the absence of polarity in HDPE. On the other hand, adhesion strength increased with increasing HDPE-g-MA content in blends. E 785 A 10 showed highest adhesion strength at 30 wt % HDPE-g-MA content in blends. Although, the adhesion of TPUs with ABS is still stronger that with functional HDPE, it TPU and functional HDPE has considerable interfacial strength for dunnage application.

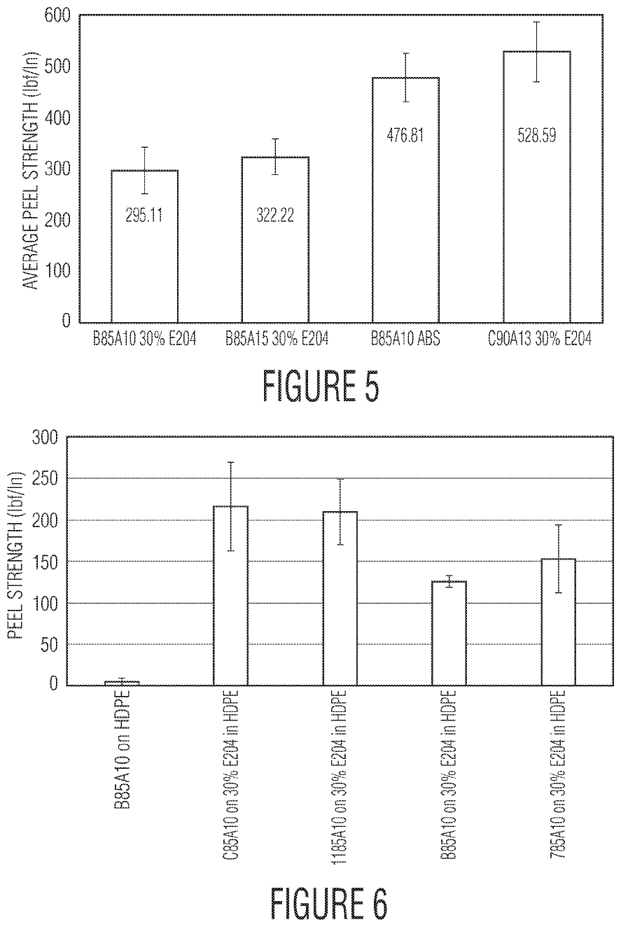

The adhesion strength of various B 85 grades and C 90 grades were also tested. As shown in FIG. 5, the t-peel strength of 30% HDPE-g-Ma containing HDPE blends with different TPUs was measured. C 90 A 10 grade exhibited improved adhesion strength with functional HDPE.

### Example 3

### Evaluation of the Interfacial Strength of Co-Extruded HDPE/TPU Sheets

As shown in FIG. 6 the adhesion strength of co-extruded sheets of functional HDPE (i.e., 30% HDPE-g-MA/70% HDPE) toward different polyester and polyether grades was evaluated. C 85 A 10 showed the best adhesion strength. However, all of the TPU grades exhibited good t-peel strength with functional HDPE.

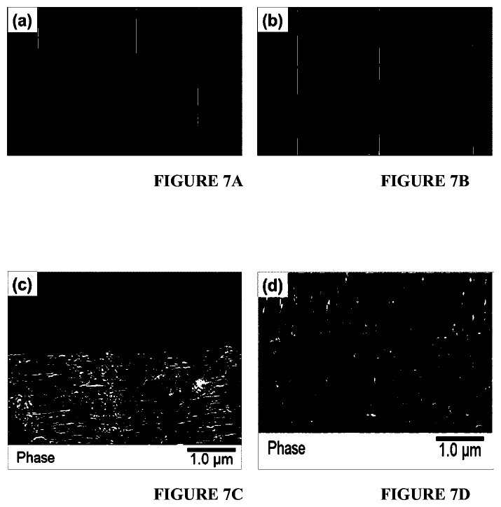

Table 10 summarizes the T-peel strength of TPU/HDPE-g-MA (varied MA %) on the adhesion strength of the coextruded sheets. Samples with HDPE-05 and HDPE-04 were not peelable since the adhesion was very strong and thus, no t-peel data are available for these samples. Thus, functionalized HDPE can also be used as the core layer of the co-extruded system with TPU. The interphases of functional HDPE with TPU was very strong as it observed in AFM images of as can be seen in FIGS. 7A-7D.

TABLE 10
T-peel strength of maleic anhydride functionalized
HDPE/TPU co-extruded systems.

| Co-extruded systems | MA % (in HDPE-g-Mas) | T-peel strength (lbf/in) |
|---|---|---|
| HDPE-NL | <0.2 | 282.80 ± 85.93 |
| HDPE-04 | 1.0 | TBD |
| HDPE-05 | 1.3 | 347.67 ± 48.85 |

### Example 4

### Evaluation of the Adhesion of Recycled Sheets of Co-Extruded TPU/HDPE-05

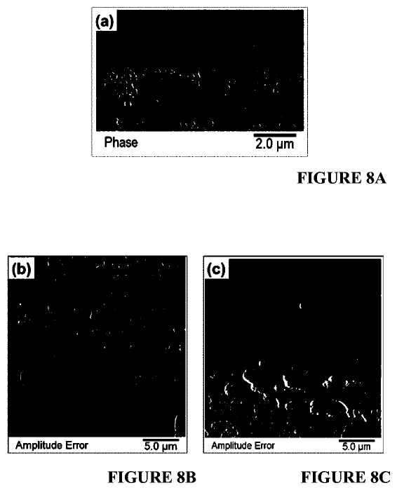

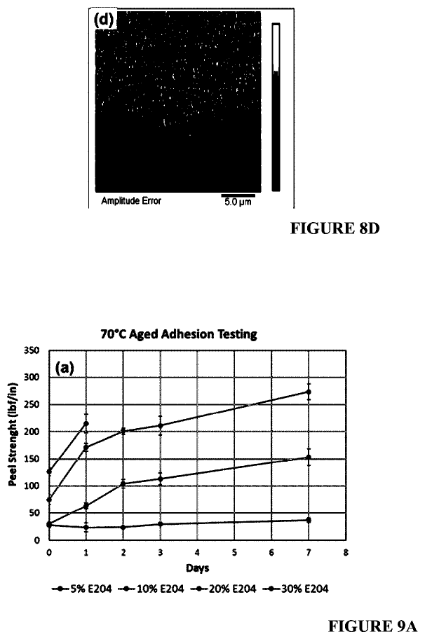

Table 11 shows the t-peel strength of recycled co-extruded TPU/HDPE-05 sheets. All recycled co-extruded sheets exhibited very good adhesion as reported in the table. Note that adhesion strength decreases with increasing the number of recycle. This could be due to the decrease in reactive species in the recycled core layer of the coextruded systems. However, the adhesion strength was higher than the as-extrude sheets. Thus, adhesion strength is well-maintained in all recycled systems. This is also due to the sharp interphase between layers of TPU and recycled core as can be seen in AMF images of FIGS. 8A-8D.

TABLE 11
T-peel strength of recycled HDPE-05/TPU co-extruded systems.

| | | T-peel strength |
|---|---|---|
| Co-extruded systems | Definitions | (lbf/in) |
| HDPE-05/B 85 A 10 | As co-extruded sheet | 347.67 ± 48.85 |
| R1/B 85 A 10 | R1 = Regrind of | 628 ± 2.89 |
| | HDPE-05/B 85 A 10 | |
| R2/B 85 A 10 | R2 = Regrind of | 559.43 ± 12.43 |
| | R1/B 85 A 10 | |
| R3/B 85 A 10 | R3 = Regrind of | 490.90 ± 28.25 |
| | R2/B 85 A 10 | |

### Example 5

### Evaluation of the Effect of Aging on the Adhesion Strength of HDPE/TPU

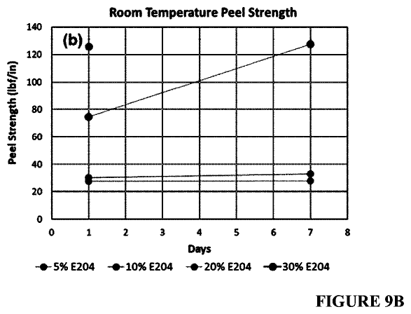

As illustrated in FIGS. 9A-9B the effect of aging in air on the adhesion strength of functional HDPE (HDPE-g-MA/HDPE blend) and E B 85 A 10 was evaluated. The co-extruded samples were put in the oven at room temperature and at 70 C for 7 days. The peel strength increases with time due to the further diffusion of reactive species in HDPE to TPU. Moreover, increase in peel strength is higher when treated at 70 C. Similarly, peel strength also increased when the samples were aged in hot water for seven days. This further indicates that the co-extruded samples would not lose adhesion over time. This phenomenon could provide extra benefit, either by allowing to use less functional polymer (such as FUSABOUND™) in the formulation, or by providing a premium product with exceptional durability.

### Example 6

### Evaluation of the Effect of Effect of Thermoforming on the Adhesion Strength

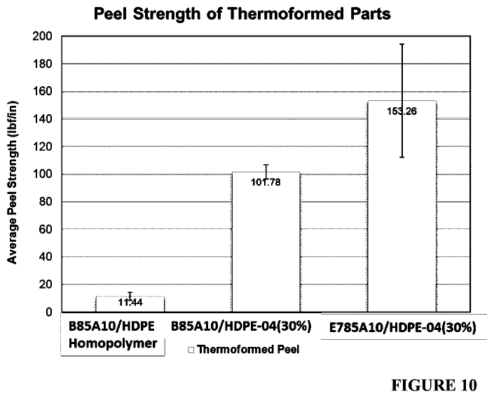

Table 12 reports the qualitative evaluation of thermoformed samples. As shown in FIG. 10 the T-peel strength of thermoformed samples of co-extruded HDPE/TPU systems was evaluated. Thermoformed samples showed good adhesion strength as compared to as-coextruded samples due to the extensional stress induced diffusion of layers. This indicates that the thermoforming would maintain good adhesion between layers in co-extruded sheets of HDPE and TPU.

TABLE 12

| Sample | Thermoformability | Opacity | Rigidity | Comments |
|---|---|---|---|---|
| B85A10, Bynel Core | Poor | Opaque | Rigid | Poor melt strength, tears at |
| | | | | corners during vacuum pull. |
| | | | | Requires slow drawing to |
| | | | | reduce tear. |
| B85A10, E205 Core | Moderate | Opaque | Rigid | Better melt strength than |
| | | | | Bynel, but still suffers from |
| | | | | corner tearing if the draw is |
| | | | | too fast. |
| B85A10, E205 R1 | Good | Translucent | Semi- | Behaves more like TPU |
| | | | Rigid | than HDPE or base co-ex. |
| | | | | Draws well, still exhibits |
| | | | | some HDPE crystallization. |
| B85A10, E205 R2 | Good | Translucent | Flexible | Behaves mostly like TPU. |
| B85A10, E205 R3 | Good | Transparent | Flexible | Behaves like TPU. |
| B85A10 | Good | Transparent | Flexible | |

Although the invention has been described with reference to the above examples, it will be understood that modifications and variations are encompassed within the spirit and scope of the invention. Accordingly, the invention is limited only by the following claims.

1. A method of producing a high-density polyethylene (HDPE)/thermoplastic polyurethane (TPU) multilayered sheet comprising co-extruding HDPE and TPU, wherein the HDPE comprises unfunctionalized HDPE and functionalized HDPE, thereby producing a HDPE/TPU multilayered sheet.

2. The method of claim 1, wherein the HDPE/TPU multilayered sheet comprises one or more layers of TPU and one or more layers of HDPE.

3. The method of claim 2, wherein the HDPE/TPU multilayered sheet comprises one layer of HDPE and one layer of TPU or one layer of HDPE and two layers of TPU.

4. The method of claim 1, wherein the functionalized HDPE comprises grafted maleic anhydride HDPE (HDPE-g-MA).

5. The method of claim 4, wherein the functionalized HDPE comprises from about 0.1 to 1.5% g-MA.

6. (canceled)

7. The method of claim 3, wherein the HDPE layer comprises from about 0.1 to 40 wt % of HDPE-g-MA.

8. (canceled)

9. The method of claim 1, wherein the HDPE is selected from the group consisting of HDPE, HDPE/NL, HDPE/04, and HDPE/05.

10. The method of claim 1, wherein the TPU is a polyester or a polyether.

11. The method of claim 10, wherein the TPU is selected from the group consisting of E B 85 A 10, E C 90 A 10, E 688 A 10, E 785 A 10, E 685 A 10, E 1180 A 10, E C 85 A 10 and E 1185 A 10.

12. The method of claim 1, wherein the HDPE/TPU multilayered sheet comprises a combination of HDPE and TPU selected from the group consisting of HDPE/E B 85 A 10, HDPE/E B 85 A 10, HDPE/E C 90 A 13, HDPE/E 688 A 10, HDPE/E 785 A 10, HDPE/E 1185 A 10, HDPE-NL/E B 85 A 10, HDPE-04/E B 85 A 10, and HDPE-05/E B 85 A 10.

13. The method of claim 1, wherein co-extruding HDPE and TPU comprises heating HDPE and TPU at a temperature that ranges from about 150° C. to 250° C.

14. (canceled)

15. A high-density polyethylene (HDPE)/thermoplastic polyurethane (TPU) multilayered sheet obtained by the method of claim 1.

16. The HDPE/TPU multilayered sheet of claim 15, wherein the HDPE/TPU multilayered sheet has an increased adhesion strength as compared to a HDPE/TPU multilayered sheet that does not comprise functionalized HDPE, or wherein the HDPE/TPU multilayered sheet has an increased t-peel strength as compared to a HDPE/TPU multilayered sheet that does not comprise functionalized HDPE, wherein the sheet has a thickness that ranges from about 1 to 5 mm, or wherein the sheet is cold resistant and/or impact resistant.

17. The HDPE/TPU multilayered sheet of claim 1645, wherein the adhesion strength increases with increasing g-MA content.

18. (canceled)

19. The HDPE/TPU multilayered sheet of claim 1518, wherein the HDPE/TPU multilayered sheet is non-peelable.

20. (canceled)

21. (canceled)

22. A method of producing a dunnage tray comprising:
(i) producing a high-density polyethylene (HDPE)/thermoplastic polyurethane (TPU) multilayered sheet, and
(ii) thermoforming the HDPE/TPU multilayered sheet,
thereby producing a dunnage tray.

23. The method of claim 22, wherein producing the HDPE/TPU multilayered sheet comprises co-extruding HDPE and TPU.

24. A dunnage tray obtained by the method of claim 22.

25. The dunnage tray of claim 24, wherein the tray is cold resistant and/or impact resistant.

26. A method of recycling a high-density polyethylene (HDPE)/thermoplastic polyurethane (TPU) dunnage tray comprising:
(i) grinding a HDPE/TPU multilayered sheet dunnage tray; and
(ii) co-extruding the grinded HDPE/TPU multilayered sheet and TPU to generate a recycled HDPE-TPU/TPU multilayered sheet,
thereby recycling the HDPE/TPU dunnage tray.

27. The method of claim 26, wherein the recycled HDPE-TPU/TPU multilayered sheet has adhesion strength and t-peel strength that are equivalent to a non-recycled HDPE-TPU/TPU multilayered sheet.
